(19) United States
(12) Patent Application Publication
(10) Pub. No.: US 2016/0189829 A1
(43) Pub. Date: Jun. 30, 2016

(54) MULTI-LAYER CABLES

(71) Applicant: GENERAL CABLE TECHNOLOGIES CORPORATION, Highland Heights, KY (US)

(72) Inventors: Eric W. Bates, Lafayette, IN (US); Sathish Kumar Ranganathan, Avon, IN (US); Timothy Allen Waters, Covington, KY (US)

(21) Appl. No.: 14/983,082

(22) Filed: Dec. 29, 2015

Related U.S. Application Data
(60) Provisional application No. 62/098,043, filed on Dec. 30, 2014.

(51) Int. Cl. H01B 7/295; H01B 7/02; H01B 3/00

(52) U.S. Cl. CPC H01B 7/295; H01B 3/004; H01B 7/0216

(57) ABSTRACT

A cable includes an inner layer surrounding a conductor and an outer layer surrounding the inner layer, and the outer layer is formed from an extruded outer layer composition including an at least partially cross-linked resin including a base polyolefin and a weak acid source, an inorganic flame retardant, and one more of an organic char former and a spumific agent. The cable passes the Underwriters Laboratory (“UL”) 1581 VW-1 Flame Spread Test and one or more of the UL 44 Long-Term Insulation Resistance Test at 90° C. and the ceramifying requirements of International Electrotechnical Commission (“IEC”) 60331-21. Methods of manufacturing such cables are also disclosed.

### REFERENCE TO RELATED APPLICATIONS

The present application claims the priority of U.S. provisional application Ser. No. 62/098,043, entitled MULTI-LAYER CABLES, filed Dec. 30, 2014, and hereby incorporates the same application herein by reference in its entirety.

### TECHNICAL FIELD

The present disclosure generally relates to cables, and more particularly to multi-layer cables having desired mechanical and electrical characteristics.

### BACKGROUND

Certain wiring applications can require cables that have been certified to pass specific physical and electrical qualifications such as fire resistance and wet electrical performance qualifications. Although such qualifications can be achieved through the use of certain insulating and jacket layers, such existing layers suffer from a number of undesirable attributes including high cost, difficulty in simultaneously achieving multiple properties, and toxicity. It would, therefore, be desirable to produce an insulated cable that can meet fire resistance and wet electrical or ceramifiable performance qualifications without the undesirable cost and toxicity of existing cable layers.

### SUMMARY

In accordance with one example, a cable includes a conductor, an inner layer surrounding the conductor, and an outer layer surrounding the inner layer. The outer layer is formed from an extruded outer layer composition. The extruded outer layer composition includes a resin, an inorganic flame retardant, and one more of an organic char former and a spumific agent. The resin includes a base polyolefin and a weak acid source. The resin is at least partially cross-linked. The cable passes the Underwriters Laboratory (UL) 1581 VW-1 Flame Spread Test and one or more of the Long-Term Insulation Resistance Test at 90° C. and the ceramifying requirements of International Electrotechnical Commission (“IEC”) 60331-21.

In accordance with another example, a cable includes a conductor, an inner layer surrounding the conductor, and an outer layer surrounding the inner layer. The outer layer is formed from an extruded outer layer composition. The extruded outer layer composition includes a resin, an inorganic flame retardant, melamine and salts and derivatives thereof, an epoxy novolac resin, and a silane compound. The resin includes a base polyolefin and a weak acid source. The resin is at least partially cross-linked. The silane compound includes a siloxane oligomer with alkyl or vinyl monomers. The cable passes the Underwriters Laboratory (“UL”) 1581 VW-1 Flame Spread Test and the UL 44 Long-Term Insulation Resistance Test at 90° C.

In accordance with another example, a cable includes a conductor, a ceramifiable inner layer surrounding the conductor, and an outer layer surrounding the inner layer. The outer layer is formed from an extruded outer layer composition. The extruded outer layer composition includes a resin, an inorganic flame retardant, melamine and salts and derivatives thereof, a polyester char former, and a silane compound. The resin includes a base polyolefin and a weak acid source. The resin is at least partially cross-linked. The silane compound includes a siloxane oligomer with alkyl or vinyl monomers. The cable passes the Underwriters Laboratory (“UL”) 1581 VW-1 Flame Spread Test and the ceramifying requirements of International Electrotechnical Commission (“IEC”) 60331-21.

### DETAILED DESCRIPTION

The electrical and physical properties of a cable can be influenced through the use of one, or more, insulation and jacket layers surrounding a conductor. Such electrical and physical properties can determine the types of applications in which a cable can be used. For example, a RHW-2 cable that has flame retardant and wet electrical properties can be used in certain conduit applications while a cable that exhibits ceramifiable properties can be used in petrochemical applications.

The use of multiple insulation and/or jacket layers can provide a synergistic benefit and can permit cables to meet more stringent electrical and physical qualification tests than similar cables having only a single layer. For example, certain cables described herein including an inner layer surrounding a conductor and an outer layer surrounding the inner layer can pass both the Underwriters Laboratory (“UL”) 1581 VW-1 Flame Spread Test and the UL 44 Long-Term Insulation Resistance (“LTIR”) Test at 90° C. In certain embodiments, such cables can also be halogen free and/or heavy metal free. In other certain examples, cables described herein including a ceramifiable inner layer and an outer layer surrounding the ceramifiable inner layer can be ceramifying cables as determined by International Electrotechnical Commission (“IEC”) 60331-21 and can pass the UL 1581 VW-1 Flame Spread Test.

Inner and outer layers described herein can individually include a number of component similarities. For example, in certain embodiments, certain components of each layer, such as, a base polyolefin or an inorganic flame retardant, can be the same, or selected from an identical list of suitable components, as the component in the other layer. However, as can be appreciated, such components can also be different depending on the design and desired properties of the cable. For example, a cable having an inner layer formed from a ceramifiable material can include a silicone resin instead of a polyolefin resin.

An outer layer that can permit a cable to pass the UL 1581 VW-1 Flame Spread Test and the UL 44 LTIR Test at 90° C. when surrounding a non-ceramifying inner layer or to pass the VW-1 Flame Spread Test and the ceramifying requirements of IEC 60331-21 when surrounding a ceramifying inner layer, can be formed from an extruded outer layer composition. Such an outer layer composition can include a cross-linkable base polyolefin, an inorganic flame retardant, a weak acid source, and one or more of an organic char former and a spumific agent. As will be appreciated, additional components can also be added to the outer layer composition according to certain embodiments.

A non-ceramifying inner layer that can permit a cable to pass the UL 1581 VW-1 Flame Spread Test and UL 44 LTIR Test at 90° C. when surrounded by an outer layer can be formed from a non-ceramifying inner layer composition. Such a non-ceramifying inner layer composition can be similar to an outer layer composition in certain aspects and can, in certain embodiments, include a base polyolefin, an inorganic flame retardant, and a surface treatment agent selected from any component suitable for such components in the outer layer composition. Non-limiting examples of compositions which can be used to form such inner layers are described in U.S. Pat. No. 9,115,274 which is herein incorporated by reference.

In certain embodiments, an inner layer can alternatively exhibit ceramifying properties and can be formed of a ceramifiable silicone resin and a filler. Suitable ceramifiable silicone resins can include hydroxy or alkyl terminated (and/or grafted) polydimethylsiloxane (“PDMS”) and polyalkyl siloxane resins. Suitable fillers for a ceramifying inner layer can include silicate fillers (e.g., one or more of magnesium silicate, aluminum silicate, and calcium silicate) and oxide fillers (e.g., one or more of silicon dioxide, titanium dioxide, and aluminum oxide). In certain embodiments, the filler can be included at about 30% to about 70% by weight of the ceramifiable inner layer with about 5% to about 50% by weight of the inner layer being a silicate filler and about 5% to about 50% by weight of the inner layer being an oxide filler. Alternatively, a ceramifiable inner layer can be formed from commercially known ceramifiable products such as one or more of Elastosil® 502 from Wacker Chemie AG and Xiameter® RBC 7160 from Dow Corning Corp.

In certain embodiments, suitable cross-linkable base polyolefins for a non-ceramifying inner layer composition or an outer layer composition can include alkene polymers such as, for example, alkene polymers formed from polymerized monomers having the general formula CₙH₂ₙ. In certain embodiments, certain examples of suitable cross-linkable base polyolefins can include polyethylene polymers including, for example: high-density polyethylene (“HDPE”), ultra-high molecular weight polyethylene (“UHMWPE”), linear low density polyethylene (“LLDPE”), and very-low density polyethylene. Other examples can include polypropylene, polybutylene, polyhexalene, and polyoctene.

According to certain embodiments, additional cross-linkable base polyolefins can also, or alternatively, be suitable including copolymers, blends, and mixtures of several different polymers. For example, a suitable cross-linkable base polyolefin can be formed from the polymerization of ethylene with at least one comonomer selected from the group consisting of C₃ to C₂₀ alpha-olefins and C₃ to C₂₀ polyenes. As will be appreciated, polymerization of ethylene with such comonomers can produce ethylene/alpha-olefin copolymers or ethylene/alpha-olefin/diene terpolymers.

According to certain embodiments, suitable alpha-olefins can alternatively contain from 3 to 16 carbon atoms or can contain from 3 to 8 carbon atoms. A non-limiting list of suitable alpha-olefins includes propylene, 1-butene, 1-pentene, 1-hexene, 1-octene, and 1-dodecene.

Likewise, according to certain embodiments, a suitable polyene can alternatively contain from 4 to 20 carbon atoms, or can contain from 4 to 15 carbon atoms. In certain embodiments, the polyene can be a diene further including, for example, straight chain dienes, branched chain dienes, cyclic hydrocarbon dienes, and non-conjugated dienes. Non-limiting examples of suitable dienes can include straight chain acyclic dienes: 1,3-butadiene; 1,4-hexadiene, and 1,6-octadiene; branched chain acyclic dienes: 5-methyl-1,4-hexadiene; 3,7-dimethyl-1,6-octadiene; 3,7-dimethyl-1,7-octadiene; and mixed isomers of dihydro myricene and dihydroocinene; single ring alicyclic dienes: 1,3-cyclopentadiene; 1,4-cylcohexadiene; 1,5-cyclooctadiene; and 1,5-cyclododecadiene; multi-ring alicyclic fused and bridged ring dienes: tetrahydroindene; methyl tetrahydroindene; dicylcopentadiene; bicyclo-(2,2,1)-hepta-2-5-diene; alkenyl; alkylidene; cycloalkenyl; and cycloalkylidene norbornenes such as 5-methylene-2morbornene (MNB); 5-propenyl-2-norbornene; 5-isopropylidene-2-norbornene; 5-(4-cyclopentenyl)-2-norbornene; 5-cyclohexylidene-2-norbornene; and norbornene.

In certain embodiments, a suitable cross-linkable base polyolefin can also be a maleic anhydride modified polyolefin (“MAMP”) such as, for example, maleic anhydride modified polyethylene. Generally, any of the preceding suitable cross-linkable base polyolefins can be modified with maleic anhydride and used as a maleic anhydride modified polyolefin in an outer layer composition and/or a non-ceramifying inner layer composition.

Generally, the cross-linkable base polyolefin can be polymerized by any suitable method including, for example, metallocene catalysis reactions. Details of metallocene catalyzation processes are disclosed in U.S. Pat. No. 6,451,894, U.S. Pat. No. 6,376,623, and U.S. Pat. No. 6,329,454, each of which are hereby incorporated by reference in their entirety into the present application. As can be appreciated, metallocene-catalyzed olefin copolymers can also be commercially obtained through various suppliers including the ExxonMobil Chemical Company (Houston, Tex.) and the Dow Chemical Company. As can be appreciated, metallocene catalysis can allow for the polymerization of precise polymeric structures.

Non-limiting examples of base polyolefins suitable for an outer layer composition can include ethylene-butene copolymer, ethylene-octene copolymer, ethylene maleic anhydride copolymer, ethylene-propylene, ethylene propylene-diene terpolymer, ethylene-propylene rubber (“EPR”), and polyethylene. In certain embodiments, such cross-linkable polyolefins can be included in an outer layer composition at about 70 parts by weight.

In certain embodiments, an outer layer composition can include a blend of more than one polymer or copolymer, and such polymers and copolymers can be present in varying amounts with the total quantity of the polymers or copolymers present at about 70 parts by weight of the outer layer composition. For example, in certain embodiments, an outer layer composition can include about 60 parts by weight ethylene butene copolymer and about 10 parts by weight ethylene maleic anhydride copolymer. In certain embodiments, the remainder of the polyolefin base can be a polymeric weak acid source such as about 30 parts of ethylene vinyl acetate. As can be appreciated, the base polyolefin and the weak acid source can constitute 100 parts of the base resin of an outer layer composition.

Similar to the outer layer compositions, examples of suitable base polyolefins for certain non-ceramifying inner layer compositions can be selected from, for example, polyethylene, ethylene butene copolymer, ethylene-octene copolymer, ethylene maleic anhydride copolymer, ethylene propylene-diene terpolymer, ethylene-propylene rubber and blends of several such polyolefins and copolymers. In certain embodiments including a blend of copolymers, such copolymers can be present in a non-ceramifying inner layer composition in various amounts. For example, in certain embodiments, a non-ceramifying inner layer composition can include about 90 parts of ethylene butene copolymer and about 10 parts of ethylene maleic anhydride copolymer.

In certain embodiments, either, or both, of an outer layer composition and a non-ceramifying inner layer composition can be at least partially cross-linked by a cross-linking agent or cross-linking method. For example, in certain embodiments, all of the components in the outer layer composition can be combined and then cross-linked. As will also be appreciated, all of the components in a composition, including the base polyolefin, can be cross-linked in a single step. Crosslinking of an outer layer composition and a non-ceramifying inner layer composition can improve the physical and rheological properties of a resulting cable.

The cross-linkable base polyolefins can be partially or fully cross-linked through any suitable cross-linking agent or method. A non-limiting example of a suitable class of cross-linking agents includes peroxide cross-linking agents such as, for example, α,α′-bis(tert-butylperoxy) disopropylbenzene, di(tert-butylperoxyisopropyl)benzene, dicumyl peroxide, and tert-butylcumyl peroxide. Blends of multiple peroxide cross-linking agents can also be used, including, for example, a blend of 1,1-dimethylethyl 1-methyl-1-phenylethyl peroxide, bis(1-methyl-1-phenylethyl) peroxide, and [1,3 (or 1,4)-phenylenebis(1-methylethylidene)] bis(1,1-dimethylethyl) peroxide. However, it will be appreciated that, in certain embodiments, other suitable cross-linking agents or methods can also be utilized to cross-link a base polyolefin, such as for example, radiation cross-linking, heat cross-linking, electron-beam irradiation, or use of silane cross-linking agents. In certain such embodiments, suitable compounds can be added to the composition to enable such alternative cross-linking. For example, an e-beam curable outer layer composition can include one or more imidazole and methacrylate cross-linking. Suitable quantities of a cross-linking agent can vary from about 1 part to about 8 parts by weight of each composition in certain embodiments; from about 1 part to about 5 parts by weight of each composition in certain embodiments; and from about 1 part to about 3 parts by weight of each composition in certain embodiments.

In certain outer layer compositions, a cross-linking co-agent can also be used to boost the cure state of an outer layer composition. For example, trimethylolpropane trimethacylate (“TMPTMA”), triallyl cyanurate (“TAC”), triallyl iso-cyanurate (“TAIC”), polybutadiene, alpha methylstyrene dimer (“AMSD”), and bismaleimide co-agents, such as N,N′-1,3-phenylene bismaleimide, can be used to improve the state of cross-linking. In certain embodiments, the co-agent can be present in an outer layer composition from about 0.5 part to about 5 parts by weight of the outer layer composition. In certain embodiments, the co-agent can be present in an outer-layer composition from about 2 parts to about 4 parts by weight of the outer layer composition.

In certain embodiments, both an outer layer composition and a non-ceramifying inner layer composition can include an inorganic flame retardant. Suitable inorganic flame retardants can include metal oxides, metal hydroxides, silicate-based fillers, and combinations thereof. Examples of such metal oxides can include aluminum oxide, magnesium oxide, iron oxide, zinc oxide, and combinations thereof. Examples of suitable metal hydroxides can include magnesium hydroxide, magnesium carbonate hydroxide, aluminum hydroxide, aluminum oxide hydroxide (e.g., “boehmite”), magnesium calcium carbonate hydroxide, zinc hydroxide and combinations thereof. Additionally, in certain outer layer or non-ceramifying inner layer compositions, an inorganic flame retardant can also include phosphorus flame retarders. Examples of such phosphorus flame retarders can include phosphoric acid compounds, polyphosphoric acid compounds, and red phosphorus compounds. Specific examples of suitable inorganic flame retardants can include kaolin, mica, talc, or silicon dioxide.

According to certain embodiments, suitable inorganic flame retardant can be further described by their mechanical and physical properties. For example, certain suitable inorganic flame retardants can have an average particle size of about 50 nm to about 500 microns. In certain embodiments, the average particle size can be about 0.8 micron to about 2.0 microns. And in certain embodiments, the average particle size can be about 0.8 micron to about 1.2 microns. Particles of an inorganic flame retardant can also vary in shape and can include spherical, hexagonal, play, tabular, platelet shapes, and other suitable shapes.

For certain outer layer compositions, an inorganic flame retardant can be included at about 90 parts to about 230 parts by weight of the outer layer composition. In certain embodiments, an inorganic flame retardant can be included from about 140 parts to about 210 parts by weight of an outer layer composition. And in certain embodiments, an inorganic flame retardant can be included from about 160 parts to about 190 parts by weight of an outer layer composition.

Likewise, certain non-ceramifying inner layer compositions can include from about 90 parts to about 230 parts by weight of an inorganic flame retardant; in certain embodiments, from about 140 parts to about 190 parts by weight of an inorganic flame retardant; and in certain embodiments from about 160 parts to about 190 parts by weight of an inorganic flame retardant. In certain embodiments, kaolin can be used as an inorganic flame retardant for a non-ceramifying inner layer composition, and in certain such embodiments kaolin can be included in a non-ceramifying inner layer composition at a higher quantity than any kaolin included in the outer layer composition.

According to certain embodiments, a weak acid source can be included in certain outer layer compositions but not intentionally included in certain inner layer compositions. Examples of such weak acid sources can include inorganic weak acids and acidic component(s) of copolymers such as, for example, vinyl acetate in ethylene vinyl-acetate copolymer. Examples of other suitable copolymers including acidic components can include ethylene-ethyl acrylate copolymer, ethylene-acrylic acid copolymer, ethylene-methyl-acrylate copolymer, and combinations thereof. The acid component of such copolymers can constitute from about 15% to about 60% of the copolymer. For example, in certain outer layer compositions including an ethylene vinyl acetate copolymer, vinyl acetate can constitute about 15% to about 60% of the copolymer with the remainder of the copolymer constituting ethylene. In certain embodiments, vinyl acetate can constitute about 28% to about 40% of the ethylene-vinyl acetate copolymer. In certain embodiments, vinyl acetate can constitute about 25% to about 40% of the ethylene vinyl acetate copolymer. According to certain embodiments, a weak acid source can be included in an outer layer composition from about 5 parts to about 60 parts by weight; and in certain embodiments from about 20 parts to about 40 parts by weight. As can be appreciated, certain weak acid sources such as ethylene vinyl acetate can be considered as part of the resin when calculating the parts by weight of an outer layer composition.

According to certain embodiments, an outer layer composition can further include an organic char former while a non-ceramifying inner layer composition can be free of any intentionally added char formers. In certain outer layer compositions, an organic char former can be selected from, for example, compounds such as novolac resins, epoxy novolac resins, benzoxirane resins, certain thermoplastic polyester elastomers, and combinations thereof.

Novolac resins can be formed as the acid-catalyzed condensation product of phenols with aldehydes. In such a reaction, suitable phenols can include phenol, cresol, xylenol, naphtol, alkylphenol and other hydrocarbol substituted phenols. Suitable aldehydes can include formaldehyde, acetaldehyde, butyaldehyde, crotonaldehyde, and glyoxal. Suitable novolac resins can, in certain embodiments, have a degree of condensation of about 2 or more. Additionally, or alternatively, in certain embodiments, the novolac resin can be only slightly cross-linked and can be a “B-staged” novolac resin and can have a molecular weight of about 1,000 or higher. In certain embodiments, a novolac resin can have a molecular weight of about 5,000 or higher. In certain embodiments, a novolac resin can have a molecular weight of about 10,000 or higher.

Suitable epoxy novolac resins can be formed by epoxidizing suitable novolac resins. For example, a suitable epoxy novolac phenol resin can be formed by reacting novolac phenol resin with epichlorohydrin in the presence of an alkali metal hydroxide. Other epoxy novolac resins, such as epoxy novolac cresol resins can be produced through similar processes.

In certain embodiments, benzoxirane can additionally, or alternatively, be used as an organic char former. Benzoxazine can be formed from the reaction of an amine, a phenol and formaldehyde. In non-limiting examples, the amine can be aniline and the phenol can be one of bisphenol A, bisphenol F, phenolphthalein, thiodiphenol, and dicyclopentadiene. In certain embodiments, the char former can also include an epoxy resin combined with a benzoxazine resin.

Examples of suitable char forming thermoplastic polyester elastomers can include block copolymers of polybutylene terephthalate and long-chain polyether glycols. For example, certain grades of Hytrel® polyester from DuPont Chemical can act as a suitable char former such as Hytrel® 4056. When such char formers are used, a suitable polyester moisture stabilizer such as Hytrel® 10MS can also be included.

It can also be appreciated that additional organic char formers can also be used according to certain embodiments. For example, other highly aromatic polymers and oligomers such as polyphenylene oxide and polyetherimide can be suitable organic char formers.

In certain embodiments, an organic char former can be included in an outer layer composition from about 4 parts to about 20 parts by weight of an outer layer composition; and in certain embodiments, from about 4 parts to about 8 parts by weight.

Additionally, or as an alternative to a char former, an outer layer composition can include a spumific agent. A non-ceramifying inner layer can, in certain embodiments, be free of any intentionally added spumific agents. According to certain embodiments, a spumific agent can be at least one of 1,3,5-triazine-2,4,6-triamine (“melamine”), a melamine salt, or a melamine derivative. Examples of suitable melamine salts and derivatives can include melamine cyanurate, melamine triborate, dimelamine phosphate, and combinations thereof. The spumific agent can, according to certain embodiments, be included in an outer layer composition, from about 15 parts to about 50 parts by weight the outer layer composition.

As can be appreciated, both a non-ceramifying inner layer composition and an outer layer composition can further include additional components/ingredients. For example, both such compositions can include a surface treatment agent.

Examples of a surface treatment agent suitable for a non-ceramifying inner layer composition or an outer layer composition can include one or more of a monomeric vinyl silane, an oligomeric vinyl silane, a polymeric vinyl silane and an organosilane compound. Suitable organosilane compounds can include: γ-methacryloxypropyltrimethoxysilane, methyltriethoxysilane, methyltris(2-methoxyethoxy)silane, dimethyldiethoxysilane, vinyltris(2-methoxyethoxy)silane, vinyltrimethoxysilane, vinyltriethoxysilane, octyltriethoxysilane, isobutyltriethoxysilane, isobutyltrimethoxysilane, propyltriethoxysilane, and mixtures or polymers thereof. As can be appreciated, any of the components in an outer layer composition or a non-ceramifying inner layer composition, such as an inorganic flame retardant of either composition, can also optionally be pre-treated with a surface treatment agent.

A surface treatment agent can be included in an outer layer composition from about 0.5 part to about 10 parts by weight the outer layer composition; and in certain embodiments, from about 0.5 part to about 5 parts by weight of the outer layer composition.

Likewise, a non-ceramifying inner layer composition can include from about 0.5 part to about 10 parts of a surface treatment agent by weight of the non-ceramifying inner layer composition. According to certain embodiments, a silane compound can be included from about 0.5 part to about 5 parts by weight of the inner layer composition.

Other components that can be included in either of certain outer layer compositions or certain inner layer compositions can include processing aids and antioxidants.

Suitable processing aids can be used to improve the processability of certain outer layer compositions and inner layer compositions by forming microscopic dispersed phases within the polymer carrier. During processing, the applied shear can separate the process aid from the carrier polymer phase. The processing aid can then migrate to the die wall to gradually form a continuous coating layer to reduce the backpressure of the extruder and reduce friction during extrusion. A processing aid can generally be a lubricant, such as, stearic acid, a silicone, an anti-static amine, an organic amitie, an ethanolamide, a mono- and/or di-glyceride fatty amine, an ethoxylated fatty amine, a fatty acid, zinc stearate, stearic acid, palmitic acid, calcium stearate, zinc sulfate, oligomeric olefin oil, or a combination thereof. In certain embodiments, a processing aid can be included at about 5 parts or less by weight of an inner layer composition or an outer layer composition; in certain embodiments at about 2 parts or less by weight of such compositions; and in certain embodiments at about 1 part or less by weight of such compositions. In certain embodiments, a composition can be substantially free of the processing aid. As used herein, “substantially free” means that the component is not intentionally added to a composition and, or alternatively, that the component is not detectable with current analytical methods.

A processing aid can alternatively be a blend of fatty acids, such as the commercially available products: Struktol® produced by Struktol Co. (Stow, Ohio), Akulon® Ultraflow produced by DSM N.V. (Birmingham, Mich.), MoldWiz® produced by Axel Plastics Research Laboratories (Woodside, N.Y.), and Aflux® produced by RheinChemie (Chardon, Ohio).

Examples of suitable antioxidants for inclusion in an outer layer composition or a non-ceramifying inner layer composition can include zinc antioxidants, amine oxidants, or combinations thereof. Specific antioxidants can include 4,4′-dioctyl diphenylamine, N,N′-diphenyl-p-phenylenediamine, and polymers of 2,2,4-trimethyl-1,2-dihydroquinoline; phenolic antioxidants, such as thiodiethylene bis [3-(3,5-di-tert-butyl-4-hydroxyphenyl)propionate], 4,4′-thiobis(2-tert-butyl-5-methylphenol), 2,2′-thiobis(4-methyl-6-tert-butyl-phenol), benzenepropanoic acid, 3,5-bis(1,1-dimethylethyl)4-hydroxy benzenepropanoic acid, 3,5-bis(1,1-dimethylethyl)-4-hydroxy-C13-15 branched and linear alkyl esters, 3,5-di-tert-butyl-4hydroxyhydrocinnamic acid C7-9-branched alkyl ester, 2,4-dimethyl-6-t-butylphenol tetrakis{methylene-3-(3′,5′-ditert-butyl-4′-hydroxyphenol)propionate}methane or tetrakis{methylene3-(3′,5′-ditert-butyl-4′-hydrocinnamate}methane, 1,1,3tris(2-methyl-4-hydroxyl-5-butylphenyl)butane, 2,5,di t-amyl hydroqunone, 1,3,5-tri methyl2,4,6tris(3,5di tert butyl-4-hydroxybenzyl)benzene, 1,3,5tris(3,5di-tert-butyl-4-hydroxybenzyl)isocyanurate, 2,2-methylene-bis-(4-methyl-6-tert butyl-phenol), 6,6′-di-tert-butyl-2,2′-thiodi-p-cresol or 2,2′-thiobis(4-methyl-6-tert-butylphenol), 2,2-ethylenebis(4,6-di-t-butylphenol), triethyleneglycol bis 3-(3-t-butyl-4-hydroxy-5methylphenyl)propionate, 1,3,5-tris(4tert-butyl-3-hydroxy-2,6-dimethylbenzyl)-1,3,5-triazine-2,4,6-(1H,3H,5H)trione, 2,2-methylenebis {6-(1-methylcyclohexyl)-p-cresol}; and/or sulfur antioxidants, such as bis(2-methyl-4-(3-n-alkylthiopropionyloxy)-5-t-butylphenyl)sulfide, 2-mercaptobenzimidazole and its zinc salts, pentaerythritol-tetrakis(3-lauryl-thiopropionate), and combinations thereof. An antioxidant can be included in a non-ceramifying inner layer or an outer layer composition, according to certain embodiments, in amounts ranging from about 0.05 part to about 6 parts by weight of the composition; and, in certain embodiments, from about 0.05 part to about 2 parts by weight of the composition.

In certain embodiments, an outer layer composition can further include additional components/ingredients not intentionally included in a non-ceramifying inner layer composition. For example, an outer layer composition can include a suitable carbon black material. One such suitable carbon black material is Thermax N-990 carbon black available from Cancarb (Alberta, Canada). Carbon black can be included in an outer layer composition from about 1 part to about 50 parts by weight of the outer layer composition according to certain embodiments.

Additionally, in certain embodiments, an outer layer composition can include a colorant. Suitable colorants can include, but are not limited to cadmium red, iron blue, or combinations thereof. As can be appreciated, carbon black can also be used, or can act, as a colorant.

According to certain embodiments, a non-ceramifying inner layer composition can similarly include other components/ingredients not intentionally included in an outer layer composition. For example, in certain embodiments, a non-ceramifying inner layer composition can include a butadiene-styrene copolymer. Suitable butadiene-styrene copolymers can have a styrene content of about 20% to about 30% and can be formed in any suitable arrangement. For example, a butadiene-styrene copolymer can have a block arrangement or a random arrangement of styrene and butadiene. In certain embodiments, a butadiene-styrene copolymer can be included in a non-ceramifying inner-layer composition from about 1 part to about 60 parts by weight of the non-ceramifying inner layer composition; in certain embodiments from about 1 part to about 15 parts by weight of the non-ceramifying inner layer composition; and in certain embodiments from about 1 part to about 10 parts by weight of the non-ceramifying inner-layer composition.

A non-ceramifying inner layer composition and an outer layer composition can each be prepared by blending the components/ingredients in conventional masticating equipment, for example, a rubber mill, brabender mixer, banbury mixer, buss ko-kneader, farrel continuous mixer, or twin screw continuous mixer. In certain examples, each of the components, other than the base polyolefin, can be premixed and then added to the base polyolefin. The mixing time can be selected to ensure a homogenous mixture.

In certain embodiments, an inner layer and an outer layer can be extruded around, and onto, a conductor to form a conductive cable having advantageous physical, mechanical, and electrical properties. In a typical extrusion method, an optionally heated conductor can be pulled through a heated extrusion die, generally a cross-head die, to apply a layer of a melted inner layer composition onto the conductor. The composition can surround, or substantially surround the conductor. Upon exiting the die, the conducting core with the applied inner layer composition can be passed through a heated vulcanizing section, or continuous vulcanizing section and then a cooling section, generally an elongated cooling bath, to cool. Multiple polymer layers, including, for example, an outer layer formed from an outer layer composition can then be applied by consecutive extrusion steps in which an additional layer is added in each step. However, as can be appreciated, alternative extrusion methods can also be used. For example, a tandem extrusion curing process can be used. In a tandem extrusion curing process, each of the various polymer layers are extruded individually and then all of the polymer layers are cured in a single curing step. Alternatively, certain extrusion dies, sometimes called tandem extrusion dies, can be used to simultaneously apply multiple polymer layers in a single step. After extrusion with a tandem extrusion die, all of the polymer layers can then be cured in a single curing step. As can be appreciated, other variations are possible. For example, in certain embodiments including a ceramifying inner layer, an irradiation cure step can be used to cure, or further cure, an outer layer composition. Suitable irradiation methods can include, for example, an about 10 MRad electron beam.

A conductor, or conductive element, of a conductive cable, can generally include any suitable electrically conducting material. For example, a generally electrically conductive metal such as, copper, aluminum, a copper alloy, an aluminum alloy (e.g. aluminum-zirconium alloy), or any other conductive metal can serve as a conductive material. As will be appreciated, a conductor can be solid, or can be twisted and braided from a plurality of smaller conductors. The conductor can be sized for specific purposes. For example, a conductor can range from a 10 to 14 American Wire Gauge (“AWG”) conductor in certain embodiments with the cable passing the UL 1581 VW-1 flame test, and the UL 44 LTIR test at 90° C. when surrounded by a non-ceramifying inner layer and an outer layer as described herein. As will also be appreciated, in certain embodiments using a polyethylene polyolefin as the base polyolefin, cables can be formed as suitable XHHW-2 cables, RHH cables, or RHW-2 cables.

When a cable includes a ceramifiable inner layer, the cable can exhibit ceramifiable properties when burned and can meet the requirements of IEC 60331-21. As can be appreciated, ceramifiable cables can be used in industries where an emergency may subject a cable to intense heat or flame such as the petrochemical industry. As used herein, ceramifiable means the cable passes the standards of IEC 60331-21.

As will be appreciated, a cable can, in certain embodiments, also include additional layers. For example, cables can include an additional jacket layer surrounding the outer layer, or an additional layer between the inner layer and the outer layer as presently described.

### Examples

Table 1 depicts the components of several outer layer compositions (Example Formulations 1-5) used to form the outer layer of a cable by weight (in parts).

TABLE 1

| | Example Formulation No. | | | | |
|---|---|---|---|---|---|
| Compound | 1 | 2 | 3 | 4 | 5 |
| Ethylene butene | 60 | 60 | 60 | 60 | — |
| copolymer | | | | | |
| Ethylene octene | — | — | — | — | 58.20 |
| copolymer | | | | | |
| Ethylene maleic | 10 | 10 | 10 | 10 | 10.00 |
| anhydride copolymer | | | | | |
| Ethylene vinyl acetate | 30 | 30 | — | — | — |
| (“EVA”) copolymer (40% | | | | | |
| VA) | | | | | |
| EVA copolymer (28% | — | — | 30 | 30 | — |
| VA) | | | | | |
| EVA copolymer (25% | — | — | — | — | 22.80 |
| VA) | | | | | |
| Precipitated magnesium | 177.9 | 177.9 | 177.9 | 177.9 | 191.0 |
| hydroxide | | | | | |
| Melamine | 27 | 27 | 27 | 27 | 27 |
| Carbon black | 13.50 | 13.50 | 13.50 | 13.50 | — |
| Oligomeric vinyl silane | 3.30 | 3.30 | 3.30 | 3.30 | 3.30 |
| Zinc-based antioxidant | 0.25 | 0.25 | 3.00 | 3.00 | 2.00 |
| Amine-type antioxidant | 1.00 | 1.00 | 1.50 | 1.50 | — |
| Phenolic-type antioxidant | — | — | — | — | 1.00 |
| Fatty acid process aid | 2.00 | 2.00 | 2.00 | 2.00 | 2.00 |
| Bis maleimide | — | 3.30 | 3.30 | — | — |
| Peroxide | 2.30 | 2.30 | 2.30 | 2.30 | — |
| Novolac resin | 6.6 | — | — | — | — |
| Benzoxirane resin | — | 5 | 5 | — | — |
| Epoxy novolac | — | — | — | 6.6 | — |
| Polyester char former | — | — | — | — | 10.50¹ |
| Radiation sensitizer | — | — | — | — | 5.50² |
| Total (parts) | 333.85 | 335.55 | 338.80 | 337.10 | 342.30 |

¹Consisting of 10.00 parts Hytrel ® 4056 polyester char former and 0.50 parts Hytrel ® 10MS polyester moisture stabilizer, both from DuPont Chemical
²Consisting of 1.50 parts m-phenylenedimaleimide and 4.00 parts trimethylolpropane trimethacrylate

Table 2 depicts the components of example inner layer compositions used to form an inner layer of a cable. Example Formulation 6 is a non-ceramifying inner layer composition and Example Formulations 7 and 8 are ceramifying inner layer compositions. The components of the composition are listed by weight (in parts).

TABLE 2

| | Example | Example | Example |
|---|---|---|---|
| | Formulation | Formulation | Formulation |
| Component | 6 | 7 | 8 |
| Ethylene Butene | 90 | — | — |
| copolymer | | | |
| Maleic | 10 | — | — |
| Anhydride | | | |
| grafted | | | |
| polyethylene¹ | | | |
| Ceramifying | — | 100 | — |
| silicone² | | | |
| Ceramifying | — | — | 100 |
| silicone³ | | | |
| Magnesium | 155 | — | — |
| hydroxide | | | |
| Silane treated | 30 | — | — |
| kaolin | | | |
| 50% Silane | 6.60 | — | — |
| dispersion in wax | | | |
| Antioxidant | 4.50 | — | — |
| Process aid | 2.00 | — | — |
| (blend of fatty | | | |
| acids) | | | |
| Polybutadiene | 6.00 | — | — |
| styrene | | | |
| copolymer | | | |
| Peroxide | 2.3 | — | — |
| Total (parts) | 306.4 | 100 | 100 |

¹Density: 0.93 g/cm3, melt flow rate (190° C./2.16 kg): 1.75 g/10 min.;
²Elastosil ® 502 from Wacker Chemie AG formed of a silicone base resin and filler
³Xiameter ® RBC-7160 from Dow Corning Corp. formed of a silicone base resin and filler

Table 3 depicts Example cables 1 to 5 having 14 American Wire Gauge (“AWG”) conductors and non-ceramifiable inner layers and outer layers extruded from the compositions set forth in Tables 1 and 2. Example cables 1 to 3 and 4 in Table 3 includes a 30 mils thick non-ceramifying inner layer constructed from Example Formulation 6 listed in Table 2, and a 15 mils thick outer layer constructed from Example Formulations 1 to 4 listed in Table 1. Cables of Comparative Examples 1 to 3 are formed with outer layer formulations 1 to 3 depicted in Table 1. Comparative Examples 4 is a control cable and includes only a single layer. Inventive Example 5 is formed with inner layer formulation 6 and outer layer formulation 4. Table 3 depicts the mechanical properties, flame retardancy, and wet electrical properties of each Example cable.

TABLE 3

| | Com- | Com- | Com- | Com- | |
|---|---|---|---|---|---|
| Cable | parative | parative | parative | parative | Inventive |
| Properties | Example 1 | Example 2 | Example 3 | Example 4 | Example 5 |
| Inner Layer | 6 | 6 | 6 | 6 | 6 |
| Formulation | | | | | |
| No. | | | | | |
| Outer Layer | 1 | 2 | 3 | — | 4 |
| Formulation | | | | | |
| No. | | | | | |
| Tensile, psi | 1756 | 1789 | 1743 | 1900 | 1544 |
| (1500 min.) | | | | | |
| Elongation, | 185 | 177 | 179 | 190 | 182 |
| % (150 min.) | | | | | |
| UL 1581 | Pass | Pass | Pass | Fail | Pass |
| VW-1 Flame | (3 of 3) | (3 of 3) | (3 of 3) | (0 of 3 | (3 of 3) |
| Spread test | | | | failed) | |
| VW-1- | 14 | 30 | 3 | 60+ | 18 |
| Requirement: | | | | | |
| Max burn | | | | | |
| time, sec. (60 | | | | | |
| sec max) | | | | | |
| VW-1- | 0 | 0 | 0 | >25% | 0 |
| Requirement: | | | | | |
| % Flag | | | | | |
| burned | | | | | |
| (<25%) | | | | | |
| VW-1- | Not | Not | Not | Not | Not |
| Requirement: | observed | observed | observed | observed | observed |
| Burning | | | | | |
| Particles (Not | | | | | |
| allowed) | | | | | |
| 75° C. | Pass | Pass | Pass | Pass | Pass |
| Capacitance | | | | | |
| test | | | | | |
| 90° C. | Fail | Pass | Pass | Pass | Pass |
| Capacitance | | | | | |
| test | | | | | |
| UL 44 Long- | Fail | Fail | Fail | Pass | Pass |
| Term | | | | | |
| Insulation | | | | | |
| Resistance | | | | | |
| Test at 90° C. | | | | | |

As illustrated in Table 3 above, the addition of a suitable outer layer imparts flame retardancy to a cable and allows the cable to pass the UL 1581 VW-1 Flame Spread Test as seen in Inventive Example 5. Additionally, the cable of Inventive Example 6 cable also passes the Long-Term Insulation Resistance Test at 90° C. as set forth under UL 44 (2010). The UL 1581 VW-1 Flame Spread Test and the UL 44 Long-Term Insulation Resistance Test at 90° C. are standard tests set forth and described in the cited UL standards and therefore it is understood that one skilled in the art would be conduct such tests using the methods described in the respective UL standards.

Table 4 depicts examples of ceramifying cables. Each of the examples in Table 4 includes a ceramifying inner layer from Example Formulations 7 or 8 in Table 2 and optionally an outer layer from Example Formulations 5 in Table 1. Each cable includes a 14 AWG conductor, a 15 mils inner layer, and a 30 mils outer layer. Two control cables are included without outer layers in Comparative Examples 8 and 9.

TABLE 4

| Cable | Comparative | Comparative | Inventive |
|---|---|---|---|
| Properties | Example 6 | Example 7 | Example 8 |
| Inner Layer | 7 | 8 | 7 |
| (Example | | | |
| Formulation | | | |
| No.) | | | |
| Outer Layer | — | — | 5 |
| (Example | | | |
| Formulation | | | |
| No.) | | | |
| Tensile, psi | >1250 | >1250 | 1250 |
| Elongation, % | >300 | >300 | 360 |
| VW-1 Flame | Fail | Fail | Pass (3 out of |
| Spread test | | | 3 passed) |
| IEC 60331-21 | Yes | Yes | Yes |
| Ceramifying | | | |
| 75° C. | — | — | 3.8 |
| Capacitance test | | | |
| (Initial SIC) | | | |
| 75° C. | — | — | 1.8 |
| Capacitance test | | | |
| (% increase | | | |
| after 7-14 days) | | | |
| 75° C. | — | — | 4.3 |
| Capacitance test | | | |
| (% increase | | | |
| after 1-14 days) | | | |

As depicted by Table 4, Inventive Example 8 is ceramifying per IEC 60331-21 and passes the UL 1581 VW-1 Flame Spread Test. Comparative Examples 6 and 7, not including an outer-layer, both fail the UL 1581 VW-1 Flame Spread Test. All of Examples 6 to 8 pass the ceramifying requirements of IEC 60331-21.

As can be appreciated, cables including only a single layer do not pass both the UL 1581 VW-1 Flame Spread test and one or more of the UL 44 LTIR test at 90° C. and the ceramifying requirements of IEC 60331-21. For example, cables formed with only a single layer formed from outer layer compositions 4 and 5 will fail to express passing results on the VW-1 Flame Spread test and also pass either the UL 44 LTIR test at 90° C. or the ceramifiable requirements of IEC 60331-21 despite such compositions passing such tests when extruded around inner layer formulation 6.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A cable comprising:
a conductor;
an inner layer surrounding the conductor; and
an outer layer surrounding the inner layer, the outer layer formed from an extruded outer layer composition, the extruded outer layer composition comprising:
a resin comprising a base polyolefin and a weak acid source, the resin being at least partially cross-linked;
an inorganic flame retardant; and
one or more of an organic char former and a spumific agent; and
wherein the cable passes the Underwriters Laboratory (“UL”) 1581 VW-1 Flame Spread Test and one or more of the UL 44 Long-Term Insulation Resistance Test at 90° C. and the ceramifying requirements of International Electrotechnical Commission (“IEC”) 60331-21.

2. The cable of claim 1, wherein the resin comprises about 70 parts, by weight, of the polyolefin, and wherein the polyolefin comprises one or more of ethylene butene, ethylene octene, and an ethylene maleic anhydride copolymer.

3. The cable of claim 1, wherein the resin comprises about 5 parts to about 60 parts, by weight, of the weak acid source, and wherein the weak acid source comprises an ethylene vinyl acetate copolymer.

4. The cable of claim 1, wherein the organic char former comprises one or more of a novolac resin, an epoxy novolac resin, a polyester char former, and a benzoxazine resin.

5. The cable of claim 4, wherein the extruded outer layer composition comprises about 4 parts to about 20 parts, by weight, of the organic char former and wherein the organic char former comprises an epoxy novolac resin.

6. The cable of claim 4, wherein the organic char former comprises a polyester char former.

7. The cable of claim 1, wherein the inorganic flame retardant comprises one or more of a metal oxide and a metal hydroxide.

8. The cable of claim 7, wherein the inorganic flame retardant comprises one or more of magnesium hydroxide and aluminum hydroxide.

9. The cable of claim 1, wherein the extruded outer layer composition comprises about 140 parts to about 210 parts, by weight, of the inorganic flame retardant.

10. The cable of claim 1, wherein the extruded outer layer composition comprises about 15 to about 50 parts, by weight, of the spumific agent, and the spumific agent comprises melamine and salts and derivatives thereof.

11. The cable of claim 1, wherein the extruded outer layer composition further comprises one or more of an antioxidant, a colorant, and a processing aid.

12. The cable of claim 1, wherein the extruded outer layer composition further comprises from about 1 part to about 50 parts, by weight, of carbon black.

13. The cable of claim 1, wherein the extruded outer layer composition further comprising a silane compound comprising a siloxane oligomer with alkyl or vinyl monomers.

14. The cable of claim 1 is substantially halogen-free, and substantially heavy metal-free.

15. The cable of claim 1, wherein the extruded outer layer composition further comprises a radiation sensitizer.

16. The cable of claim 1, wherein the inner layer is formed from an extruded ceramifiable inner layer composition and the cable passes the ceramifying requirements of IEC 60331-21.

17. The cable of claim 1, wherein the inner layer is formed from an extruded inner layer composition, the extruded inner layer composition comprising:
a second base polyolefin;
an inner layer inorganic flame retardant; and
a surface treatment agent; and
wherein the cable passes the UL 44 Long-Term Insulation Resistance Test at 90° C.

18. The cable of claim 1, wherein the conductor is sized between 10 American Wire Gauge (AWG) and 14 AWG and the inner layer has a thickness of about 15 mils to about 40 mils and the outer layer has a thickness from about 5 mils to about 25 mils.

19. A cable comprising:
a conductor;
an inner layer surrounding the conductor; and
an outer layer surrounding the inner layer, the outer layer formed from an extruded outer layer composition, the extruded outer layer composition comprising:
a resin comprising a base polyolefin and a weak acid source, the resin being at least partially cross-linked;
an inorganic flame retardant;
melamine and salts and derivatives thereof;
an epoxy novolac resin; and
a silane compound comprising a siloxane oligomer with alkyl or vinyl monomers; and
wherein the cable passes the Underwriters Laboratory (“UL”) 1581 VW-1 Flame Spread Test and the UL 44 Long-Term Insulation Resistance Test at 90° C.

20. A cable comprising:
a conductor;
a ceramifiable inner layer surrounding the conductor; and
an outer layer surrounding the inner layer, the outer layer formed from an extruded outer layer composition, the extruded outer layer composition comprising:
a resin comprising a base polyolefin and a weak acid source, the resin being at least partially cross-linked;
an inorganic flame retardant;
melamine and salts and derivatives thereof;
a polyester char former; and
a silane compound comprising a siloxane oligomer with alkyl or vinyl monomers; and
wherein the cable passes the Underwriters Laboratory (“UL”) 1581 VW-1 Flame Spread Test and the ceramifying requirements of International Electrotechnical Commission (“IEC”) 60331-21.
